(19) United States
(12) Patent Application Publication
(10) Pub. No.: US 2024/0211312 A1
(43) Pub. Date: Jun. 27, 2024

(54) NODE SYMMETRY IN MACHINE LEARNING COMPILER OPTIMIZATION

(71) Applicant: QUALCOMM Incorporated, San Diego, CA (US)

(72) Inventors: Weiliang ZENG, San Diego, CA (US); Christopher LOTT, San Diego, CA (US); Edward TEAGUE, San Diego, CA (US); Yang YANG, San Diego, CA (US); Wonseok JEON, San Diego, CA (US); Muntasir Amin MALLICK, North York (CA); Mukul GAGRANI, San Diego, CA (US); Piero ZAPPI, La Jolla, CA (US); Joseph Binamira SORIAGA, San Diego, CA (US)

(21) Appl. No.: 18/086,611

(22) Filed: Dec. 21, 2022

(51) Int. Cl. G06F 9/50

(52) U.S. Cl. CPC G06F 9/5027

(57) ABSTRACT

A processor-implemented method for compiler optimization using node symmetry includes receiving a representation of an artificial neural network (ANN) include multiple nodes coupled via multiple edges. One or more symmetric sets of nodes are determined based on one or more of a set of attributes for each node or a connectivity of the nodes via the edges. One or more of an order or a schedule for executing the nodes is generated based on the one or more symmetric sets of nodes.

### FIELD OF THE DISCLOSURE

Aspects of the present disclosure generally relate to compilers.

### BACKGROUND

Artificial neural networks may comprise interconnected groups of artificial neurons (e.g., neuron models). The artificial neural network may be a computational device or be represented as a method to be performed by a computational device. Artificial neural networks, including feed forward neural networks, convolutional neural networks (CNNs), transformers, graph neural networks (GNNs), recurrent neural networks (RNNs), etc., have numerous applications. In particular, these neural network architectures are used in various technologies, such as image recognition, speech recognition, acoustic scene classification, keyword spotting, autonomous driving, and other classification tasks.

Given the many useful applications of neural networks, there is increasing demand for use thereof on edge devices such as smartphones. However, edge devices have limited computational resources and generalized models may utilize more complex networks and more computation. As such, the memory footprint and high latency for neural networks make their use challenging, particularly for efficient deployment and inference on resource-limited devices.

One approach to reducing the latency in neural networks is via machine learning accelerators. Machine learning accelerators include dedicated processors designed to accelerate machine learning computations, such as multiply accumulate operations in matrix-matrix and matrix-vector operations. To employ machine learning accelerators, machine learning compilers provide a mapping from a trained machine learning model to a given machine learning accelerator. Machine learning compilers aim to optimize the mapping from the machine learning model to the accelerator.

Conventional approaches for determining the mapping may employ heuristic strategies designed for general input distributions that are not tailored for problem-specific input distributions. Furthermore, the solution space for determining the mapping or scheduling for executing operations of a machine learning model may be very large, thereby limiting application of such optimization techniques.

### SUMMARY

The present disclosure is set forth in the independent claims, respectively. Some aspects of the disclosure are described in the dependent claims.

In aspects of the present disclosure, a processor-implemented method includes receiving a representation of an artificial neural network (ANN) including multiple nodes coupled via multiple edges. The method also includes determining one or more symmetric sets of nodes based on one or more of a set of attributes for each node or a connectivity of the nodes via the edges. The method further includes generating one or more of an order or a schedule for executing the nodes based on the one or more symmetric sets of nodes.

Other aspects of the present disclosure are directed to an apparatus. The apparatus has a memory and one or more processors coupled to the memory. The processor(s) is configured to receive a representation of an artificial neural network (ANN) including multiple nodes coupled via multiple edges. The processor(s) is also configured to determine one or more symmetric sets of nodes based on one or more of a set of attributes for each node or a connectivity of the nodes via the edges. The processor(s) is further configured to generate one or more of an order or a schedule for executing the nodes based on the one or more symmetric sets of nodes.

Other aspects of the present disclosure are directed to an apparatus. The apparatus includes means for receiving a representation of an artificial neural network (ANN) including multiple nodes coupled via multiple edges. The apparatus also includes means for determining one or more symmetric sets of nodes based on one or more of a set of attributes for each node or a connectivity of the nodes via the edges. The apparatus further includes means for generating one or more of an order or a schedule for executing the nodes based on the one or more symmetric sets of nodes.

In other aspects of the present disclosure, a non-transitory computer-readable medium with program code recorded thereon is disclosed. The program code is executed by a processor and includes program code to receive a representation of an artificial neural network (ANN) including multiple nodes coupled via multiple edges. The program code further includes program code to determine one or more symmetric sets of nodes based on one or more of a set of attributes for each node or a connectivity of the nodes via the edges. The program code still further includes program code to generate one or more of an order or a schedule for executing the nodes based on the one or more symmetric sets of nodes.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram illustrating an exemplary software architecture 400 that may modularize artificial intelligence (AI) functions.

FIG. 5A is a block diagram illustrating an example pipeline for generating an order for executing a neural network model via an accelerator.

FIG. 5B is a diagram illustrating an example pipeline for scheduling execution of operation of a compute graph.

FIG. 6 is a diagram illustrating an example portion of a tiled compute graph, in accordance with aspects of the present disclosure.

FIG. 7 is a diagram illustrating an example portion of a real-world compute graph, in accordance with aspects of the present disclosure.

FIG. 8 is a diagram illustrating an example ordering of nodes based on symmetry, in accordance with aspects of the present disclosure.

FIG. 9 is a flow diagram illustrating a process for determining symmetric sets, in accordance with aspects of the present disclosure.

FIG. 10 is a flow diagram illustrating a processor-implemented method for generating an order for executing nodes of a compute graph, in accordance with aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As described, neural network architectures are used in various technologies, such as image recognition, speech recognition, acoustic scene classification, keyword spotting, autonomous driving, and other classification tasks. However, the memory footprint and high latency for neural networks make their use challenging, particularly for efficient deployment and inference on resource-limited devices.

One approach to reducing the latency in neural networks is via machine learning accelerators. To employ machine learning accelerators, machine learning compilers provide a mapping from a trained machine learning model to a given machine learning accelerator. Machine learning compilers aim to optimize the mapping from the machine learning model to the accelerator. However, conventional approaches for determining the mapping may use heuristic strategies unsuitable for problem-specific input distributions and the solution space for determining the mapping for a machine learning model may be very large, thus limiting application of such optimization techniques.

One goal in machine learning compilers is to find sequencing and scheduling solutions (e.g., mapping) to improve or optimize key performance indicators (KPIs) such as inferences per second (IPS), memory (e.g., dynamic random access memory (DRAM) read/write bandwidth, memory footprint, or power consumption, for instance. For purposes of clarity, sequencing may refer to determining a sequence or order for execution of operations. Scheduling may refer to determining the operations to be executed on a given hardware resource (e.g., processors such as neural processing units (NPUs) or memory).

One challenge in machine learning compilers is the large solution space. The number of valid sequences (may also be referred to as “topological orders”) for a compute graph may be given by O(N!), where N is the total number of nodes in the compute graph and where the compute graph is a graphical representation of a topology of operations in a neural network model. Compute graphs may be generated after tiling a neural network model. Tiling may refer to separating one neural network layer into multiple artificial neurons. These artificial neurons may then be grouped and represented as a kernel or a node.

Compute graphs for such neural network models may have tens of thousands of nodes. Compute graphs may include nodes to represent operations in the neural network model. The nodes may be connected by edges that may represent dependencies (e.g., precedence constraint) or an order of execution. Additionally, balancing data locality (e.g., for reuse of the data) and parallelism given a compute graph and available hardware resources is a non-deterministic polynomial-time (NP)-hard problem.

Some conventional solutions may attempt to restrict solution space using a depth-first or a breadth-first approach. A depth-first search (DFS) is a process for traversing graphs in a depth-ward direction using a stack data structure. DFS starts at a root node and explores each branch until reaching a node with no unvisited neighbor nodes and then backtracking to traverse the next branch in the graph to generate an order. A breadth-first search (BFS) on the other hand, starts at the root node and explores all nodes at the same depth before exploring nodes at the next depth level to generate an order. The depth-first approaches often target to optimize locality but may result in hardware under-utilization and thus decreases in inferences per second (IPS). The breadth-first approaches are often targeted to optimize parallelism, but may result in infeasible solutions (e.g., topological orders that do not satisfy memory constraint).

On the other hand, some conventional solutions aim to use heuristic approaches in an attempt to balance data locality and parallelism. However, the large search space renders such methods ineffective in determining a solution in a limited time period.

To address these and other challenges, aspects of the present disclosure are directed to determining an order of execution based on node symmetry. Nodes in a compute graph may be considered symmetric if the nodes have the same or similar attributes or if the nodes have the same or similar node neighborhoods (e.g., connectivity). Symmetric nodes may be grouped in one or more symmetric sets. In some aspects, the one or more symmetric sets may be determined based on a search space size and an extent of symmetry. An order of the nodes in each symmetric set may be determined. The order of the nodes in each symmetric set may be considered a partial order as each symmetric set includes a subset of the nodes of the compute graph. Moreover, the partial order of the nodes in each symmetric set may be determined in advance of determining the topological order for the entire compute graph. As such, the search space may be substantially reduced from the number of nodes in the compute graph. Furthermore, the topological order and scheduling of the nodes may be determined based on one or more of a precedence constraint or a hardware (e.g., memory) constraint.

Accordingly, aspects of the present disclosure may beneficially enable improved balancing of data locality and parallelism by reducing the search space using node symmetry. As such, the reduced search space may be searched more deeply to determine a more optimal topological orders and schedules.

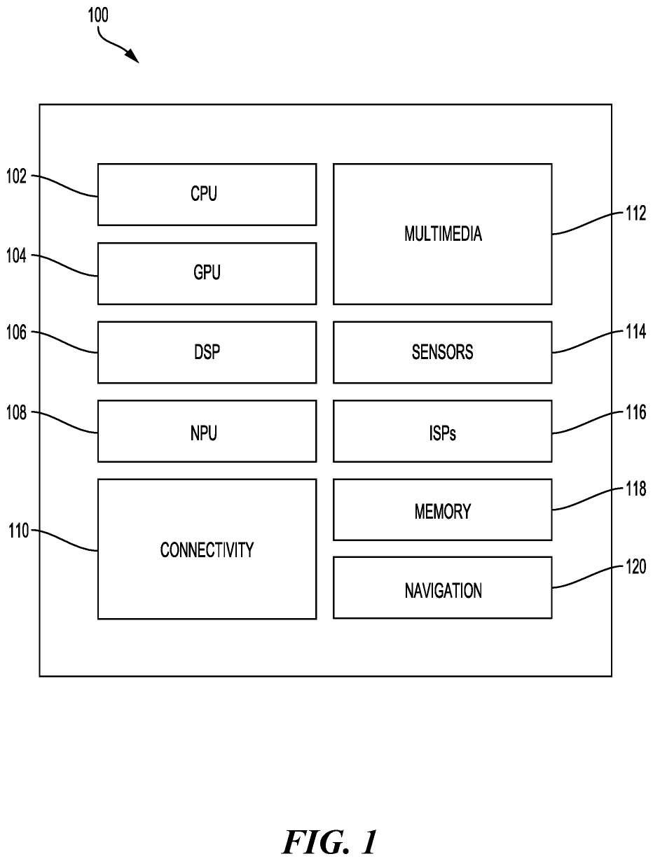

FIG. 1 illustrates an example implementation of a system-on-a-chip (SOC) 100, which may include a central processing unit (CPU) 102 or a multi-core CPU configured for determining an order for executing nodes based on node symmetry. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In an aspect of the present disclosure, the instructions loaded into the general-purpose processor 102 may include code to receive a representation of an artificial neural network (ANN) including multiple nodes coupled via multiple edges. The general-purpose processor 102 may also include code to determine one or more symmetric sets of nodes based on one or more of a set of attributes for each node or a connectivity of the nodes via the multiple edges. Additionally, the general-purpose processor 102 may include code to generate an order for executing the nodes based on the one or more symmetric sets of nodes.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

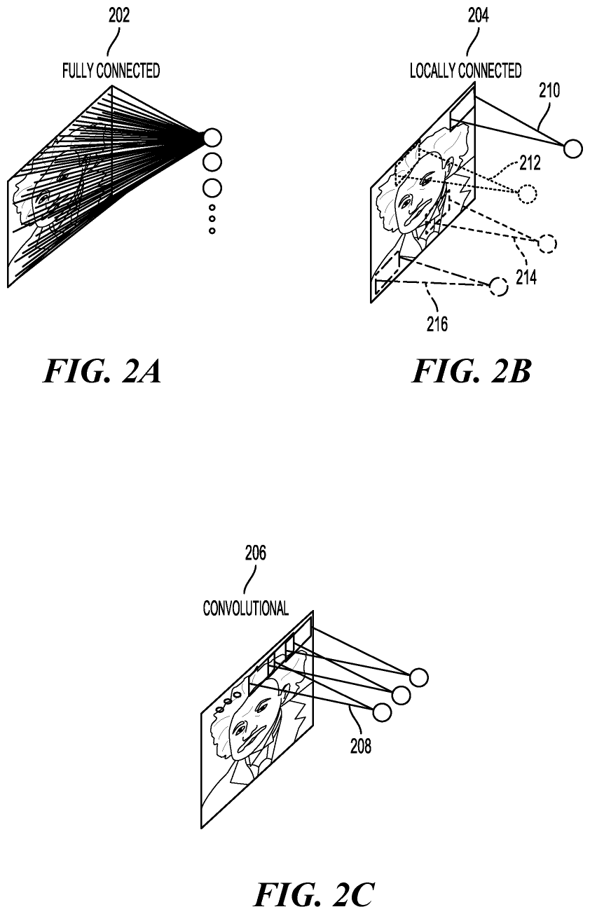

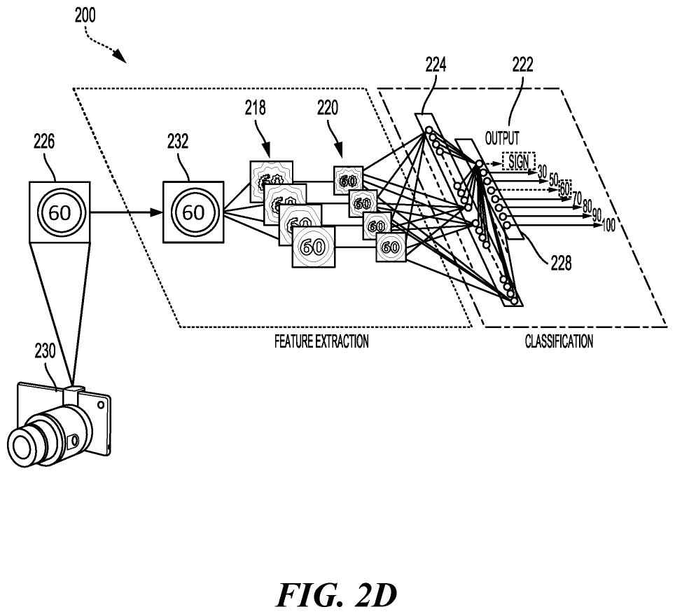

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28x28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

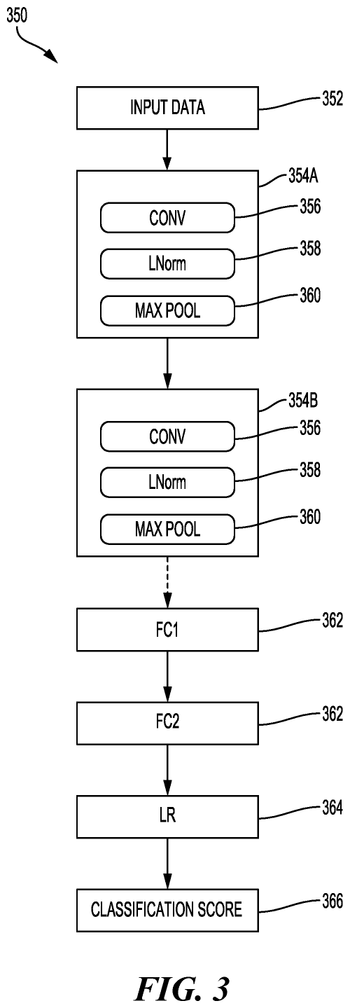

FIG. 3 is a block diagram illustrating a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

The convolution layers 356 may include one or more convolutional filters, which may be applied to the input data to generate a feature map. Although only two of the convolution blocks 354A, 354B are shown, the present disclosure is not so limiting, and instead, any number of the convolution blocks 354A, 354B may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 to achieve high performance and low power consumption. In alternative embodiments, the parallel filter banks may be loaded on the DSP 106 or an ISP 116 of an SOC 100. In addition, the deep convolutional network 350 may access other processing blocks that may be present on the SOC 100, such as sensor processor 114 and navigation module 120, dedicated, respectively, to sensors and navigation.

The deep convolutional network 350 may also include one or more fully connected layers 362 (FC1 and FC2). The deep convolutional network 350 may further include a logistic regression (LR) layer 364. Between each layer 356, 358, 360, 362, 364 of the deep convolutional network 350 are weights (not shown) that are to be updated. The output of each of the layers (e.g., 356, 358, 360, 362, 364) may serve as an input of a succeeding one of the layers (e.g., 356, 358, 360, 362, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

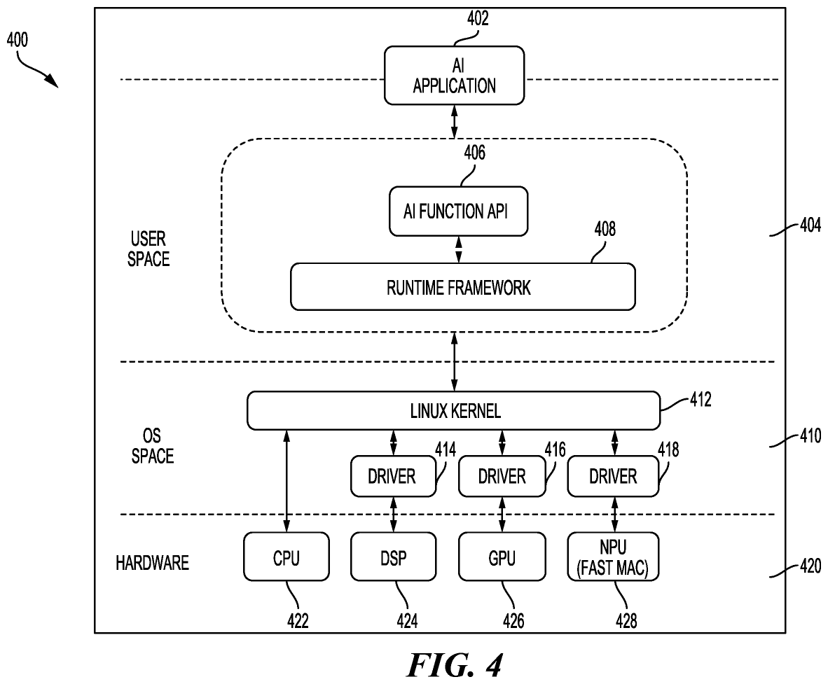

FIG. 4 is a block diagram illustrating an exemplary software architecture 400 that may modularize artificial intelligence (AI) functions. Using the architecture, applications may be designed that may cause various processing blocks of a system-on-a-chip (SOC) 420 (for example a CPU 422, a DSP 424, a GPU 426 and/or an NPU 428) to support adaptive rounding as disclosed for post-training quantization for an AI application 402, according to aspects of the present disclosure.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an Al function application programming interface (API) 406. This request may ultimately rely on the output of a deep neural network configured to provide an inference response based on video and positioning data, for example.

A run-time engine 408, which may be compiled code of a runtime framework, may be further accessible to the AI application 402. The AI application 402 may cause the run-time engine, for example, to request an inference at a particular time interval or triggered by an event detected by the user interface of the application. When caused to provide an inference response, the run-time engine may in turn send a signal to an operating system in an operating system (OS) space, such as a Linux Kernel 412, running on the SOC 420. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

The application 402 (e.g., an AI application) may be configured to call functions defined in a user space 404 that may, for example, provide for the detection and recognition of a scene indicative of the location in which the device currently operates. The application 402 may, for example, configure a microphone and a camera differently depending on whether the recognized scene is an office, a lecture hall, a restaurant, or an outdoor setting such as a lake. The application 402 may make a request to compiled program code associated with a library defined in a SceneDetect application programming interface (API) 406 to provide an estimate of the current scene. This request may ultimately rely on the output of a differential neural network configured to provide scene estimates based on video and positioning data, for example.

A run-time engine 408, which may be compiled code of a Runtime Framework, may be further accessible to the application 402. The application 402 may cause the run-time engine, for example, to request a scene estimate at a particular time interval or triggered by an event detected by the user interface of the application. When caused to estimate the scene, the run-time engine may in turn send a signal to an operating system 410, such as a Linux Kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the differential neural network may be configured to run on a combination of processing blocks, such as a CPU 422 and a GPU 426, or may be run on an NPU 428.

As described, aspects of the present disclosure are directed to determining one or more of an order or a schedule of execution based on node symmetry. In accordance with aspects of the present disclosure, symmetric nodes in a compute graph may be used to reduce the search space. This is because a real-world compute graph may have many regularities. That is, many nodes in a compute graph may appear similar. For example, many nodes in the compute graph may have the same or similar attributes or neighborhood structure (e.g., connectivity). The process of tiling separates neural network layers into multiple nodes. Each node of a given layer may have the same or similar attributes such as path length, output size, node type, duration, or other attributes, for example. In addition, each node of the layer may have the same neighborhood structure, such as connectivity to nodes tiled from other neural network layers. As such, using the node symmetry may beneficially provide substantial reduction in the search space. Because of the reduced search space, improved searching due to reduced search space and/or learning processes may, for example, be employed to balance locality and parallelism. Therefore, aspects of the present disclosure may reduce latency and power consumption and may improve other key performance indicators (KPIs) for machine learning (ML) compilers.

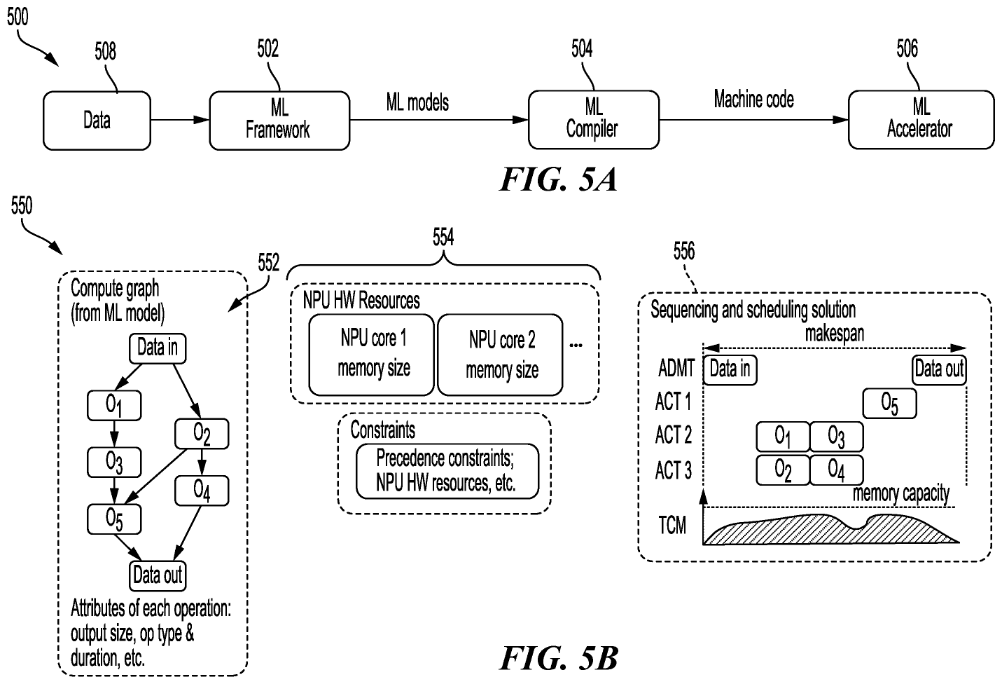

FIG. 5A is a block diagram illustrating an example pipeline 500 for generating an order for executing a neural network model via an accelerator. Referring to FIG. 5A, the pipeline 500 includes a ML framework module 502, an ML compiler 504, and an ML accelerator 506. The ML framework module 502 receives data 508 and uses the data 508 to a generate ML model. The data 508 may, for example, comprise numerical data (e.g., continuous data or discrete data), categorical data (e.g., data representing characteristics), time series data, text or other data types. In some aspects, the data may be pre-processed, for instance, to format raw data, to address missing data, or detect outliers in the data. The ML framework module 502 processes the data 508 to train the ML model based, for example on the data type. The ML framework module may employ supervised learning (e.g., regression or classification) or unsupervised learning (e.g., clustering) to train the ML model. The ML model may then be supplied to the ML compiler 504. The ML compiler 504, in turn generates machine code for operating an ML model on a given ML accelerator 506. The ML accelerator may comprise a neural processing unit (NPU), a digital signal processor (DSP), or a tensor processing unit (TPU), for example.

FIG. 5B is a diagram illustrating an example pipeline 550 for scheduling execution of operation of a compute graph. Referring to FIG. 5B, a compute graph 552 is shown. The compute graph 552 includes multiple nodes (e.g., a data in node, nodes 01-05, and a data out node) connected by a set of edges. In some aspects, the compute graph 552 may be a direct acyclic graph (DAG), for example. A DAG is a finite directed graph with no direct cycles. That is, each edge is associated with a direction from a start node to an end node indicated by the arrow of the edge, and there are no closed loops formed along any path in the graph.

To generate a schedule for executing the nodes of the compute graph 552, various constraints 554 may be observed. For example, the availability of hardware (HW) resources (e.g., type of threads (e.g., accelerator data (movement) threads (ADMTs), accelerator compute threads (ACTs)) in processors (NPU, DSP, TPU)), number of processors, or memory size) as well as precedence constraints (e.g., node dependencies) and other hardware constraints may be used to generate a schedule. A schedule 556 may be generated and may begin with executing the data in a node via an accelerator data movement thread (ADMT). Thereafter, the subsequent nodes in the compute graph 552 may be assigned to an accelerator compute processing thread (e.g., ADMTs and ACTs) and also accelerators when the hardware is available and the memory does not exceed the memory constraint (e.g., memory capacity). The nodes may be added to the schedule 556 until all nodes in the graph are included in the schedule 556. As described, one goal is to reduce, and in some aspects, to optimize the schedule such that the latency (e.g., shown in the schedule as makespan) for executing the compute graph 552 may be reduced.

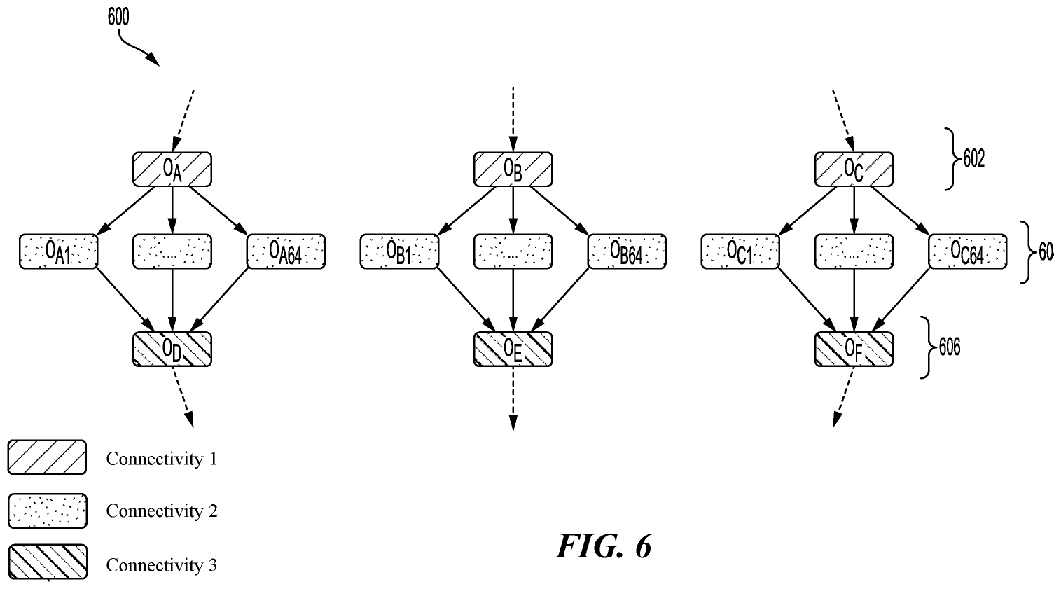

FIG. 6 is a diagram illustrating an example portion of a tiled compute graph 600, in accordance with aspects of the present disclosure. Tiling may refer to separating one neural network layer into multiple artificial neurons. These artificial neurons are grouped and represented as a kernel or a node. As described, aspects of the present disclosure may take advantage of the similarity and regularity in a compute graph structure. Referring to FIG. 6, the tiled compute graph 600 may highlight the similarity between nodes, as many of the nodes have similar connectivity. For instance, each of the input nodes 602 (e.g., OA, OB, and Oc) has a connection from a preceding tiled layer (not shown) and has similar connectivity (e.g., connectivity 1) to sets of intermediate nodes 604. The intermediate nodes 604 likewise have similar connectivity (e.g., connectivity 2) with each other. That is, each of the nodes has a connection to a corresponding input node 602 and an output node 606. Further, the output nodes 606 have similar connectivity (e.g., connectivity 3) with each other, because each of the output nodes has a connection from each of a corresponding set of intermediate nodes 604 as well as a connection to a successor node of a next tiled layer (not shown). Because the input nodes 602 have similar connectivity, the input nodes may be considered symmetric.

In some aspects, nodes that have the same or similar attributes (e.g., path length, output size, node type, duration, or other attributes) may also be considered symmetric. Additionally, nodes of the same neural network layer may have the same attributes. Further, nodes of the same neural network layer may have the same neighborhood structure. Nodes that are symmetric may be grouped in a symmetric set. A partial order for execution may be determined for each symmetric set. For example, in some aspects, a partial order may be determined using a graph layout process. The graph layout process may generate position information for a pictorial representation of a graph. The position information may then be sorted and used as a partial order for each symmetric set.

As another example, in some aspects, a partial order may be determined using a topological sort such as depth-first search, a breadth-first search, or the like, for instance. A depth-first search (DFS) is a process for traversing graphs in a depth-ward direction using a stack data structure. DFS starts at a root node and explores each branch until reaching a node with no unvisited neighbor nodes and then backtracking to traverse the next branch in the graph to generate an order. A breadth-first search (BFS) on the other hand, starts at the root node and explores all nodes at the same depth before exploring nodes at the next depth level to generate an order. The topological sort of nodes in each symmetric set may then be used as a partial order. By ordering nodes based on their symmetric set, rather than the entire compute graph, the search space may be reduced.

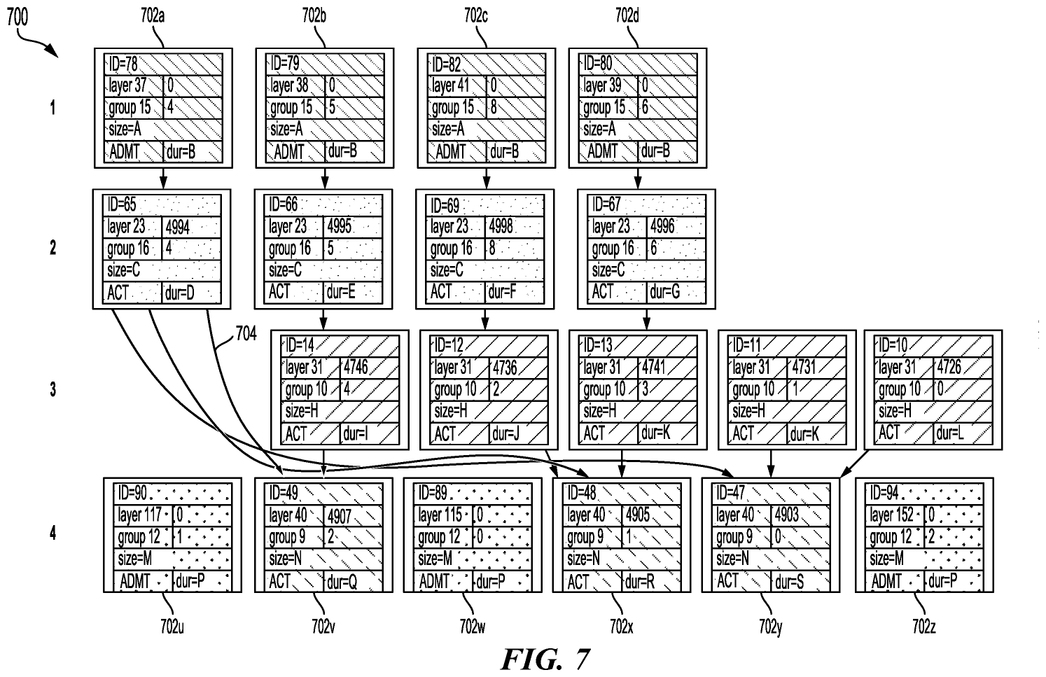

FIG. 7 is a diagram illustrating an example portion of a real-world compute graph 700, in accordance with aspects of the present disclosure. As shown in FIG. 7, the compute graph 700 includes multiple nodes 702 connected by edges. For brevity and ease of illustration, only nodes 702a-d and 702u-z are labeled. However, it should be understood that the other boxes in FIG. 7 also represent nodes of the compute graph 700. Likewise, only one edge 704 is labeled. However, it should be understood that each arrow between nodes represents an edge. Additionally, a number is included on the left of each row of nodes, which may be referred to as a level of the graph, for ease of explanation. The compute graph 700 may be received as an input of a compiler (e.g., 504 of FIG. 5A), for example. In some aspects, the compute graph 700 may be a directed acyclic graph.

Each of the nodes 702a-z may represent an operation to be executed, for instance, in an artificial neural network (e.g., 350 shown in FIG. 3). Each of the nodes (e.g., 702a-z), includes a set of attributes. For instance, each node may include attributes such as an identification (ID) number, a layer number, a group number, a size, an indication of the hardware device for execution (e.g., ADMT, ACT), or a duration. As described, nodes having the same or similar attributes may be considered symmetric and included in the same symmetric set. For example, each of the input nodes (e.g., nodes 702a-d of level 1) have the same size (e.g., A), the same duration (e.g., B), and indicate the same hardware device for execution (e.g., ADMT). Because these input nodes (e.g., nodes 702a-d of level 1) have the same attributes, these input nodes (e.g., nodes 702a-d of level 1) may be considered symmetric and may be included in the same symmetric set (indicated by the same pattern fill).

In some aspects, nodes that have the same or similar neighborhoods (e.g., connectivity) may also be included in the same symmetric set. For example, nodes 702v, 702x, and 702y each have a connection (e.g., an edge) from a level 2 predecessor node and a level 3 predecessor node. Based on the similar connectivity, nodes 702v, 702x, and 702y may be included in the same symmetric set. Similarly, nodes 702u, 702w; and 702z have no connection from a predecessor node and may be included in the same symmetric set. In this way, the nodes of the compute graph 700 may be included in one or more symmetric sets. In some aspects, symmetric sets may also be determined based on the extent of symmetry or search space size considerations. In, turn, an order for executing the nodes in each symmetric set may be determined. Although the symmetric sets shown in FIG. 7 include nodes in the same level, this is merely for ease of illustration and not limiting. Rather, it should be understood that nodes in different levels (e.g., 1-4) may be included in the same symmetric set.

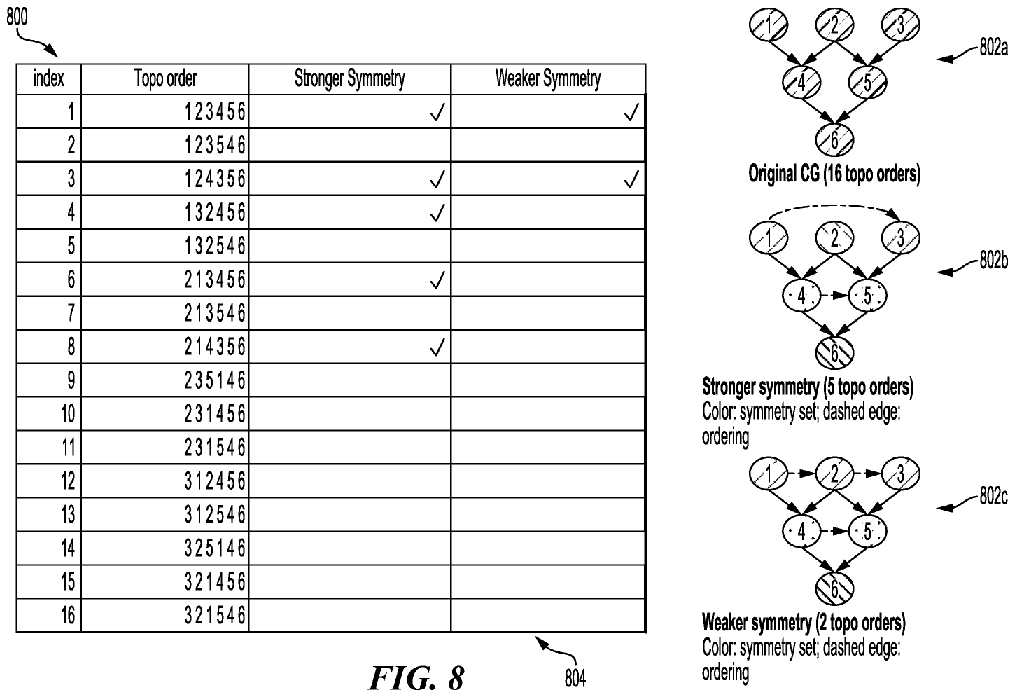

FIG. 8 is a diagram 800 illustrating an example ordering of nodes based on symmetry, in accordance with aspects of the present disclosure. Referring to FIG. 8, a simple compute graph 802a includes six nodes for which an order is to be determined. As indicated in a chart 804, the search space before applying node symmetry includes sixteen possible solutions (e.g., orders, which may also be referred to as topological orders). As described, the search space may be reduced based on node symmetry. However, in some aspects, the degree of symmetry used for determining the symmetric sets may be adjusted to further reduce the search space. In a compute graph 802b, a more strict symmetry (e.g., stronger symmetry) is applied. For instance, in the compute graph 802b, nodes 1 and 3 have the same connectivity. That is, both nodes have a connection to a single successor node (e.g., node 1 is only connected to node 4 and node 3 is only connected to node 5.) On the other hand, node 2 is connected to two successor nodes (e.g., node 4 and node 5). Because stronger symmetry is applied (e.g., nodes may be considered symmetric if the nodes have the same connectivity as opposed to similar connectivity), node 2 is not included in the same symmetric set as nodes 1 and 3. Ordering the nodes in each symmetric set, nodes 1 and 3 may be executed before node 2. Accordingly, the search space may be reduced to five possible orders (shown in the stronger symmetry column of chart 804) in view of the precedence constraints (e.g., dependencies among the nodes).

In a compute graph 802c, a more relaxed symmetry (e.g., weaker symmetry) is applied. For instance, in the compute graph 802b, nodes 1 and 3 have the same connectivity. That is, both nodes have a connection to a single successor node (e.g., node 1 is only connected to node 4 and node 3 is only connected to node 5.) Node 2 has similar connectivity to that of nodes 1 and 3, because like node 1, node 2 is connected to node 4 and like node 3, node 2 is connected to successor node 5. Thus, because a more relaxed symmetry (e.g., weaker symmetry) is applied, nodes 1-3 may be included in the same symmetric set. Accordingly, the search space may be further reduced to two possible orders (e.g., shown in the weaker symmetry column of chart 804) in view of the precedence constraints. Having reduced the search space, an order may be selected from the possible order using a graph layout process, a DFS process, a BFS process, or a topological sort, for example.

Accordingly, the degree of symmetry may operate as a control for reducing the search space. For example, this may be beneficially applied to reduce the search space based on the compute capabilities (e.g., processing speed, memory size) such that if operating on architecture with less compute capabilities weaker symmetry may be employed and if operating on architecture with more compute capabilities stronger symmetry may be employed.

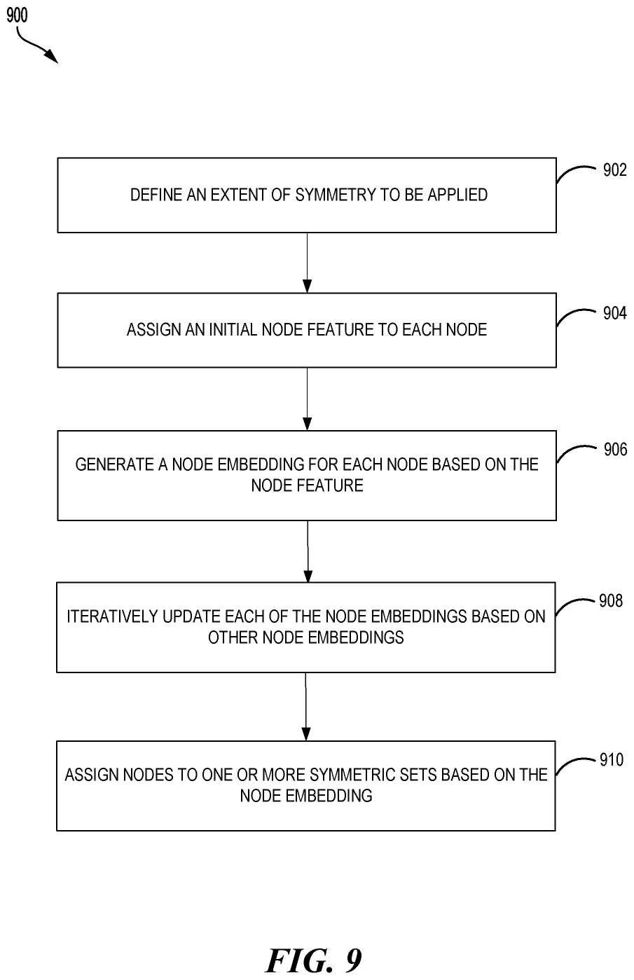

FIG. 9 is a flow diagram illustrating a process for determining symmetric sets, in accordance with aspects of the present disclosure. Referring to FIG. 9, at block 902, the process 900 may optionally define an extent of symmetry or search space reduction to be applied. For example, stricter (stronger) symmetry may be defined by using more node features. Conversely, more relaxed (weaker) symmetry may be defined by using fewer node features.

At block 904, the process 900 assigns an initial node feature c⁽⁰⁾(n) to each node n, where 0 represents the iteration in the node embedding definition of Equation 1). For instance, features may include node attributes such as node operation type (DMA, NPU, DSP, etc.), path length (shortest/longest) from source node, output tensor size, duration, or other attributes.

At block 906, the process 900 generates a node embedding for each node based on the node feature. A node embedding may be considered a representation of a node as a vector. For example, a node embedding may be given by:

$${c}^{( k )} ( n ) = H ( \{ {c}^{( k - 1 )} ( n ) , {\{ {c}^{( k - 1 )} ( u ) \}}_{u ∈ N ( n )} \} ) , k = 1 , ⋯ , K \qquad ( 1 )$$

where c^{(K)}(n) represents the node embedding at iteration k, H is a function that maps the aggregated embedding of set of nodes to a value, and N(n) represents a neighbor of node n and may include predecessors and/or successors of node n. In some aspects H may comprise an injective function. An injective function that maps elements of a given set to a distinct elements of another set. Neighbor information from previous node embeddings (e.g., c^{(k-1)}(u)) may be aggregated with its own embedding (e.g., c^{(k-1)}(n)) to update each node embedding, where the variable u represents the index for a node in the neighborhood of node n.

Using the example node embedding defined in Equation 1, stricter (stronger) symmetry may be defined by using a larger number of iterations K and injective function for H for node embeddings based on more node features. On the other hand, more relaxed (weaker) symmetry may be defined by using larger number of iterations K and injective function for H for node embeddings based on fewer node features.

At block 908, the process 900 may optionally iteratively update each of the node embeddings based on other node embeddings (e.g., embeddings of neighbor nodes).

At block 910, the process 900 assigns nodes to one or more symmetric sets based on the node embedding. For example, nodes with the same embedding value c^{(k+1)} may be assigned to the same symmetric set.

Furthermore, in accordance with aspects of the present disclosure, after determining the symmetric sets, a partial order for executing each of the nodes in a symmetric set may be determined. In some aspects, the partial order may be determined using a graph layout process, a tie-breaking process, a sequencing process, or a combination thereof, for example. With this partial order, one or both of the order and the schedule for executing nodes of the compute graph can be further determined because the search space is reduced. Partial order refers to the order in the symmetric set, whereas order refers to the full order of the graph.

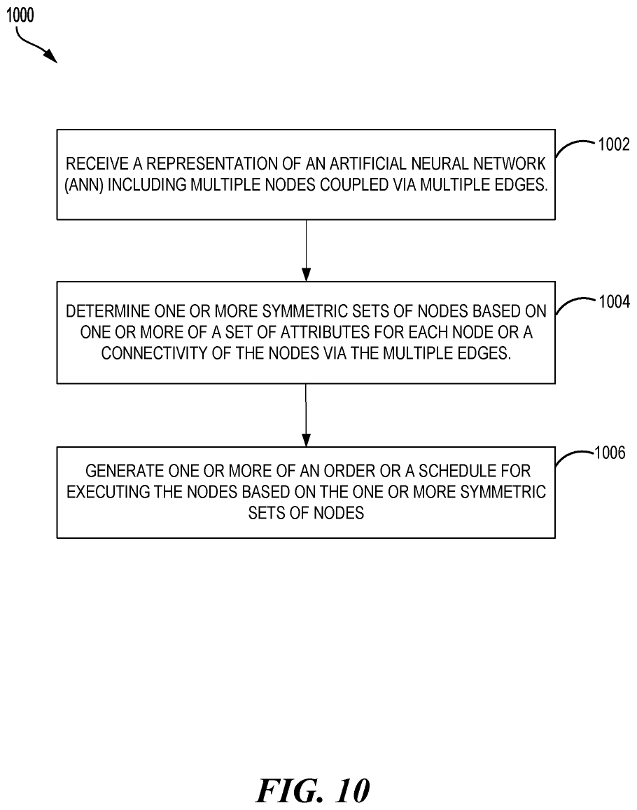

FIG. 10 is a flow diagram illustrating a processor-implemented method 1000 for generating an order for executing nodes of a compute graph, in accordance with aspects of the present disclosure. As shown in FIG. 10, at block 1002, the processor-implemented method 1000 receives a representation of an artificial neural network (ANN) including multiple nodes coupled via multiple edges. For instance, as described with reference to FIG. 7, a compute graph 700 may be received as an input of a compiler (e.g., 504), for example. Using a compute graph may beneficially enable further reduction in power consumption and latency because of the sparsity within the representation. In some aspects, the representations of an ANN may comprise a matrix or another representation of the ANN.

Each of the nodes 702a-z may represent an operation to be executed, for instance, in an artificial neural network (e.g., 350 shown in FIG. 3). Each of the nodes (e.g., 702a-z) includes a set of attributes. For instance, each node may include attributes such as an identification (ID) number, a layer number, a group number, a size, an indication of the hardware device for execution (e.g., DMA, NPU, TPU), or a duration.

At block 1004, the processor-implemented method 1000 determines one or more symmetric sets of nodes based on one or more of a set of attributes for each node or a connectivity of the nodes via the multiple edges. For instance, as described with reference to FIG. 7, nodes having the same or similar attributes may be considered symmetric and included in the same symmetric set. each of the input nodes (e.g., nodes 702a-d of level 1) have the same size (e.g., A), the same duration (e.g., B), and indicate the same hardware device for execution (e.g., ADMT). Because these input nodes (e.g., nodes 702a-d of level 1) have the same attributes, these input nodes (e.g., nodes 702a-d of level 1) may be considered symmetric and may be included in the same symmetric set (indicated by the same pattern fill). In some aspects, nodes that have the same or similar neighborhoods (e.g., connectivity) may also be included in the same symmetric set. For example, nodes 702v, 702x, and 702y each have a connection (e.g., an edge) from a level 2 predecessor node and a level 3 predecessor node. Based on the similar connectivity, nodes 702v, 702x, and 702y may be included in the same symmetric set. Similarly, nodes 702u, 702w, and 702z have no connection from a predecessor node and may be included in the same symmetric set.

At block 1006, the processor-implemented method 1000 generates one or more of an order or a schedule for executing the nodes based on the one or more symmetric sets of nodes. For example, as shown in FIG. 8, one or more topological orders may be determined based on the symmetric sets. For instance, where a more strict symmetry is applied, the search space may be reduced and five possible orders (e.g., as shown in chart 804) are determined in view of the precedence constraints (e.g., dependencies among the nodes). In some aspects, the order may be a schedule for executing the nodes of the compute graph. For example, as shown in FIG. 5B, the schedule 556 for executing the nodes of the compute graph 552 is generated based on various constraints 554. For example, the availability of hardware resources (e.g., type of processors (NPU or TPU), number of processors, or memory size) as well as precedence constraints (e.g., node dependencies) and other hardware constraints may be used to generate a schedule.

### Example Aspects

Aspect 1: A processor-implemented method comprising: receiving a representation of an artificial neural network (ANN) including multiple nodes coupled via multiple edges; determining one or more symmetric sets of nodes based on one or more of a set of attributes for each node or a connectivity of the nodes via the multiple edges; and generating one or more of an order or a schedule for executing the nodes based on the one or more symmetric sets of nodes.
Aspect 2: The processor-implemented method of Aspect 1, further comprising: assigning at least one attribute to each node; determining a node embedding for each node based on an aggregation of attributes for one or more of a predecessor node and/or a successor node; and assigning the nodes to one of the one or more symmetric sets of nodes based on the determined node embedding.
Aspect 3: The processor implemented method of Aspect 1 or 2, further comprising determining the one or more symmetric sets of nodes based on a search space size and an extent of symmetry.
Aspect 4: The processor-implemented method of any of the preceding Aspects, further comprising iteratively updating the node embedding for each node based on other node embeddings.
Aspect 5: The processor-implemented method of any of the preceding Aspects, in which the one or more of the order or the schedule in each symmetric set is determined based on at least one of a graph layout process, a tie-breaking process, or a sequencing process.
Aspect 6: The processor-implemented method of any of the preceding Aspects, in which the set of attributes includes one or more of a path length, a node type, an output tensor size, or a node execution duration, and the processor-implemented method further comprises assigning the nodes having one or more of a same path length, a same node type, a same output tensor size or a same node execution duration to a symmetric set of the one or more symmetric sets of nodes.
Aspect 7: The processor-implemented method of any of the preceding Aspects, in which the representation comprises a compute graph.
Aspect 8: The processor-implemented method of any of the preceding Aspects, in which the representation comprises a compute graph and the method further comprises generating the one or more of the order or the schedule for executing the nodes of the compute graph via a processing device.
Aspect 9: An apparatus comprising: a memory; and at least one processor coupled to the memory, the at least one processor configured: to receive a representation of an artificial neural network (ANN) including multiple nodes coupled via multiple edges; to determine one or more symmetric sets of nodes based on one or more of a set of attributes for each node or a connectivity of the nodes via the multiple edges; and to generate one or more of an order or a schedule for executing the nodes based on the one or more symmetric sets of nodes.
Aspect 10: The apparatus of Aspect 9, in which the at least one processor is further configured: to assign at least one attribute to each node; to determine a node embedding for each node based on an aggregation of attributes for one or more of a predecessor node and/or a successor node; and to assign the nodes to one of the one or more symmetric sets of nodes based on the determined node embedding.
Aspect 11: The apparatus of Aspect 9 or 10, in which the at least one processor is further configured to determine the one or more symmetric sets of nodes based on a search space size and an extent of symmetry.
Aspect 12: The apparatus of any of the Aspects 9-11, in which the at least one processor is further configured to iteratively update the node embedding for each node based on other node embeddings.
Aspect 13: The apparatus of any of the Aspects 9-12, in which the one or more of the order or the schedule in each symmetric set is determined based on at least one of a graph layout process, a tie-breaking process, or a sequencing process.
Aspect 14: The apparatus of any of the Aspects 9-13, in which the set of attributes includes one or more of a path length, a node type, an output tensor size, or a node execution duration, and in which the at least one processor is further configured to assign the nodes having one or more of a same path length, a same node type, a same output tensor size or a same node execution duration to a symmetric set of the one or more symmetric sets of nodes.
Aspect 15: The apparatus of any of the Aspects 9-14, in which the representation comprises a compute graph.
Aspect 16: The apparatus of any of the Aspects 9-15, in which the representation comprises a compute graph and the at least one processor is further configured to generate the one or more of the order or the schedule for executing the nodes of the compute graph via a processing device.
Aspect 17: An apparatus comprising: means for receiving a representation of an artificial neural network (ANN) including multiple nodes coupled via multiple edges; means for determining one or more symmetric sets of nodes based on one or more of a set of attributes for each node or a connectivity of the nodes via the multiple edges; and means for generating one or more of an order or a schedule for executing the nodes based on the one or more symmetric sets of nodes.
Aspect 18: The apparatus of Aspect 17, further comprising: means for assigning at least one attribute to each node; means for determining a node embedding for each node based on an aggregation of attributes for one or more of a predecessor node and/or a successor node; and means for assigning the nodes to one of the one or more symmetric sets of nodes based on the determined node embedding.
Aspect 19: The apparatus of Aspect 17 or 18, further comprising means for determining the one or more symmetric sets of nodes based on a search space size and an extent of symmetry.
Aspect 20: The apparatus of any of the Aspects 17-19, further comprising means for iteratively updating the node embedding for each node based on other node embeddings.
Aspect 21: The apparatus of any of the Aspects 17-20, in which the one or more of the order or the schedule in each symmetric set is determined based on at least one of a graph layout process, a tie-breaking process, or a sequencing process.
Aspect 22: The apparatus of any of the Aspects 17-21, in which the set of attributes includes one or more of a path length, a node type, an output tensor size, or a node execution duration, and further comprising means for assigning the nodes having one or more of a same path length, a same node type, a same output tensor size or a same node execution duration to a symmetric set of the one or more symmetric sets of nodes.
Aspect 23: The apparatus of any of the Aspects 17-22, in which the representation comprises a compute graph.
Aspect 24: The apparatus of any of the Aspects 17-23, in which the representation comprises a compute graph and the apparatus further comprises means for generating the one or more of the order or the schedule for executing the nodes of the compute graph via a processing device.
Aspect 25: A non-transitory computer-readable medium having program code recorded thereon, the program code executed by a processor and comprising: program code to receive a representation of an artificial neural network (ANN) including multiple nodes coupled via multiple edges; program code to determine one or more symmetric sets of nodes based on one or more of a set of attributes for each node or a connectivity of the nodes via the multiple edges; and program code to generate one or more of an order or a schedule for executing the nodes based on the one or more symmetric sets of nodes.
Aspect 26: The non-transitory computer-readable medium of Aspect 25, in which the program code further comprises: program code to assign at least one attribute to each node; program code to determine a node embedding for each node based on an aggregation of attributes for one or more of a predecessor node and/or a successor node; and program code to assign the nodes to one of the one or more symmetric sets of nodes based on the determined node embedding.
Aspect 27: The non-transitory computer-readable medium of Aspect 25 or 26, in which the program code further comprises program code to determine the one or more symmetric sets of nodes based on a search space size and an extent of symmetry.
Aspect 28: The non-transitory computer-readable medium of any of the Aspects 25-27, in which the program code further comprises program code to iteratively update the node embedding for each node based on other node embeddings.
Aspect 29: The non-transitory computer-readable medium of any of the Aspects 25-28, in which the one or more of the order or the schedule in each symmetric set is determined based on at least one of a graph layout process, a tie-breaking process, or a sequencing process.
Aspect 30: The non-transitory computer-readable medium of any of the Aspects 25-29, in which the set of attributes includes one or more of a path length, a node type, an output tensor size, or a node execution duration, and further comprising program code to assign the nodes having one or more of a same path length, a same node type, a same output tensor size or a same node execution duration to a symmetric set of the one or more symmetric sets of nodes.

In I one aspect, the receiving means, determining means, and/or generating means may be the GPU 104, program memory associated with the GPU 104, fully connected layers 362, NPU 428, and/or the routing connection processing unit 216 configured to perform the functions recited. In another configuration, the aforementioned means may be any module or any apparatus configured to perform the functions recited by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray R disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A processor-implemented method comprising:
receiving a representation of an artificial neural network (ANN) including multiple nodes coupled via multiple edges;
determining one or more symmetric sets of nodes based on one or more of a set of attributes for each node or a connectivity of the nodes via the multiple edges; and
generating one or more of an order or a schedule for executing the nodes based on the one or more symmetric sets of nodes.

2. The processor-implemented method of claim 1, further comprising:
assigning at least one attribute to each node;
determining a node embedding for each node based on an aggregation of attributes for one or more of a predecessor node and/or a successor node; and
assigning the nodes to one of the one or more symmetric sets of nodes based on the determined node embedding.

3. The processor implemented method of claim 2, further comprising determining the one or more symmetric sets of nodes based on a search space size and an extent of symmetry.

4. The processor-implemented method of claim 2, further comprising iteratively updating the node embedding for each node based on other node embeddings.

5. The processor-implemented method of claim 1, in which the one or more of the order or the schedule in each symmetric set is determined based on at least one of a graph layout process, a tie-breaking process, or a sequencing process.

6. The processor-implemented method of claim 1, in which the set of attributes includes one or more of a path length, a node type, an output tensor size, or a node execution duration, and the processor-implemented method further comprises assigning the nodes having one or more of a same path length, a same node type, a same output tensor size or a same node execution duration to a symmetric set of the one or more symmetric sets of nodes.

7. The processor-implemented method of claim 1, in which the representation comprises a compute graph.

8. The processor-implemented method of claim 1, in which the representation comprises a compute graph and the processor-implemented method further comprises generating the one or more of the order or the schedule for executing the nodes of the compute graph via a processing device.

9. An apparatus comprising:
a memory; and
at least one processor coupled to the memory, the at least one processor configured:
to receive a representation of an artificial neural network (ANN) including multiple nodes coupled via multiple edges;
to determine one or more symmetric sets of nodes based on one or more of a set of attributes for each node or a connectivity of the nodes via the multiple edges; and
to generate one or more of an order or a schedule for executing the nodes based on the one or more symmetric sets of nodes.

10. The apparatus of claim 9, in which the at least one processor is further configured:
to assign at least one attribute to each node;
to determine a node embedding for each node based on an aggregation of attributes for one or more of a predecessor node and/or a successor node; and
to assign the nodes to one of the one or more symmetric sets of nodes based on the determined node embedding.

11. The apparatus of claim 10, in which the at least one processor is further configured to determine the one or more symmetric sets of nodes based on a search space size and an extent of symmetry.

12. The apparatus of claim 10, in which the at least one processor is further configured to iteratively update the node embedding for each node based on other node embeddings.

13. The apparatus of claim 9, in which the one or more of the order or the schedule in each symmetric set is determined based on at least one of a graph layout process, a tie-breaking process, or a sequencing process.

14. The apparatus of claim 9, in which the set of attributes includes one or more of a path length, a node type, an output tensor size, or a node execution duration, and in which the at least one processor is further configured to assign the nodes having one or more of a same path length, a same node type, a same output tensor size or a same node execution duration to a symmetric set of the one or more symmetric sets of nodes.

15. The apparatus of claim 9, in which the representation comprises a compute graph.

16. The apparatus of claim 9, in which the representation comprises a compute graph and the at least one processor is further configured to generate the one or more of the order or the schedule for executing the nodes of the compute graph via a processing device.

17. An apparatus comprising:
means for receiving a representation of an artificial neural network (ANN) including multiple nodes coupled via multiple edges;
means for determining one or more symmetric sets of nodes based on one or more of a set of attributes for each node or a connectivity of the nodes via the multiple edges; and
means for generating one or more of an order or a schedule for executing the nodes based on the one or more symmetric sets of nodes.

18. The apparatus of claim 17, further comprising:
means for assigning at least one attribute to each node;
means for determining a node embedding for each node based on an aggregation of attributes for one or more of a predecessor node and/or a successor node; and
means for assigning the nodes to one of the one or more symmetric sets of nodes based on the determined node embedding.

19. The apparatus of claim 18, further comprising means for determining the one or more symmetric sets of nodes based on a search space size and an extent of symmetry.

20. The apparatus of claim 18, further comprising means for iteratively updating the node embedding for each node based on other node embeddings.

21. The apparatus of claim 17, in which the one or more of the order or the schedule in each symmetric set is determined based on at least one of a graph layout process, a tie-breaking process, or a sequencing process.

22. The apparatus of claim 17, in which the set of attributes includes one or more of a path length, a node type, an output tensor size, or a node execution duration, and further comprising means for assigning the nodes having one or more of a same path length, a same node type, a same output tensor size or a same node execution duration to a symmetric set of the one or more symmetric sets of nodes.

23. The apparatus of claim 17, in which the representation comprises a compute graph.

24. The apparatus of claim 17, in which the representation comprises a compute graph and the apparatus further comprises means for generating the one or more of the order or the schedule for executing the nodes of the compute graph via a processing device.

25. A non-transitory computer-readable medium having program code recorded thereon, the program code executed by a processor and comprising:
program code to receive a representation of an artificial neural network (ANN) including multiple nodes coupled via multiple edges;
program code to determine one or more symmetric sets of nodes based on one or more of a set of attributes for each node or a connectivity of the nodes via the multiple edges; and
program code to generate one or more of an order or a schedule for executing the nodes based on the one or more symmetric sets of nodes.

26. The non-transitory computer-readable medium of claim 25, in which the program code further comprises:
program code to assign at least one attribute to each node;
program code to determine a node embedding for each node based on an aggregation of attributes for one or more of a predecessor node and/or a successor node; and
program code to assign the nodes to one of the one or more symmetric sets of nodes based on the determined node embedding.

27. The non-transitory computer-readable medium of claim 26, in which the program code further comprises program code to determine the one or more symmetric sets of nodes based on a search space size and an extent of symmetry.

28. The non-transitory computer-readable medium of claim 26, in which the program code further comprises program code to iteratively update the node embedding for each node based on other node embeddings.

29. The non-transitory computer-readable medium of claim 25, in which the one or more of the order or the schedule in each symmetric set is determined based on at least one of a graph layout process, a tie-breaking process, or a sequencing process.

30. The non-transitory computer-readable medium of claim 25, in which the set of attributes includes one or more of a path length, a node type, an output tensor size, or a node execution duration, and further comprising program code to assign the nodes having one or more of a same path length, a same node type, a same output tensor size or a same node execution duration to a symmetric set of the one or more symmetric sets of nodes.
